(19) United States
(12) Patent Application Publication
(10) Pub. No.: US 2007/0044880 A1
(43) Pub. Date: Mar. 1, 2007

(54) Tire for golf cart

(75) Inventor: Gordon Liao, Yung Kang City (TW)

Correspondence Address: NIKOLAI & MERSEREAU, P.A., 900 SECOND AVENUE SOUTH, SUITE 820, MINNEAPOLIS, MN, 55402, US

(73) Assignee: Unique Product & Design Co., Ltd., Yung Kang City (TW)

(21) Appl. No.: 11/219,618

(22) Filed: Sep. 1, 2005

(51) Int. Cl. B60C 27/00

(52) U.S. Cl. 152/175

(57) ABSTRACT

A tire for a golf cart includes an inner tire, and a thin outer tire mounted around the inner tire. The inner tire made of EVA solid foam material co-operates with the thin outer tire having a plurality of protruding bosses to construct a solid composite tire, so that the tire has a light weight, needs not to be inflated and has a better shock-absorbing effect. In addition, the pointed cylindrical shaped protruding bosses of the thin outer tire can be extended into the muddy or snowy ground to provide an excellent grip effect, so that the golf cart can be moved smoothly and conveniently. Thus, the tire has an excellent ground grip effect, so that the tire is available for the muddy or snowy ground.

### BACKGROUND OF THE INVENTION

1. Field of the Invention

The present invention relates to a tire, and more particularly to a tire for a golf cart.

2. Description of the Related Art

A conventional tire for a golf cart includes a rubber thin tire, a rubber inflatable tire and an EVA solid foam tire.

The conventional rubber thin tire 1 as shown in FIG. 5 has a thin wall so that it has worse shock-absorbing effect and is not popular.

The conventional rubber inflatable tire 2 as shown in FIG. 6 is like the tire of a bicycle and has an inner tire. The rubber inflatable tire 2 has a heavier weight. In addition, the rubber inflatable tire 2 has a smaller contact area with the ground so that it easily leaves a tread on the soft ground, thereby breaking the grass of the golf course. In addition, the rubber inflatable tire 2 needs inflation and maintenance.

The conventional EVA solid foam tire 3 as shown in FIG. 7 has a light weight, needs not to be inflated and has a better shock-absorbing effect, so that it is popular with the people.

However, the rubber inflatable tire 2 and the EVA solid foam tire 3 are only available for the dry grass at the sunny days and easily produce slip or are trapped in the muddy or snowy ground when the ground is wet during the rainy or snowy days. In addition, when the rubber inflatable tire 2 is to increase its contact area with the ground and to thicken the tread so as to enhance its ground grip effect, the tire will have a heavier weight and will be very expensive, so that the rubber inflatable tire 2 is not available for the golf cart. In addition, the tread of the EVA solid foam tire 3 cannot be increased due to limit of the production condition, thereby greatly limiting the ground grip effect of the EVA solid foam tire 3.

### SUMMARY OF THE INVENTION

In accordance with the present invention, there is provided a tire for a golf cart, comprising an inner tire made of EVA solid foam material, and a thin outer tire mounted around the inner tire. The inner tire has an outer wall formed with a plurality of transverse slots. The thin outer tire has an inner wall formed with a plurality of transverse ribs locked in the transverse slots of the inner tire respectively. The thin outer tire has an outer wall formed with a plurality of protruding bosses.

The primary objective of the present invention is to provide a tire for a golf cart, wherein the tire has an excellent ground grip effect, so that the tire is available for the muddy or snowy ground.

Another objective of the present invention is to provide a tire for a golf cart, wherein the inner tire made of EVA solid foam material co-operates with the thin outer tire having a plurality of protruding bosses to construct a solid composite tire, so that the tire has a light weight, needs not to be inflated and has a better shock-absorbing effect.

A further objective of the present invention is to provide a tire for a golf cart, wherein the pointed cylindrical shaped protruding bosses of the thin outer tire can be extended into the muddy or snowy ground to provide an excellent grip effect, so that the golf cart can be moved smoothly and conveniently.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a tire for a golf cart in accordance with a first preferred embodiment of the present invention.

FIG. 2 is a plan cross-sectional assembly view of the tire as shown in FIG. 1.

FIG. 3 is an exploded perspective view of a tire for a golf cart in accordance with a second preferred embodiment of the present invention.

FIG. 4 is a plan cross-sectional assembly view of the tire as shown in FIG. 3.

FIG. 5 is a perspective view of a first conventional tire for a golf cart in accordance with the prior art.

FIG. 6 is a perspective view of a second conventional tire for a golf cart in accordance with the prior art.

FIG. 7 is a perspective view of a third conventional tire for a golf cart in accordance with the prior art.

### DETAILED DESCRIPTION OF THE INVENTION

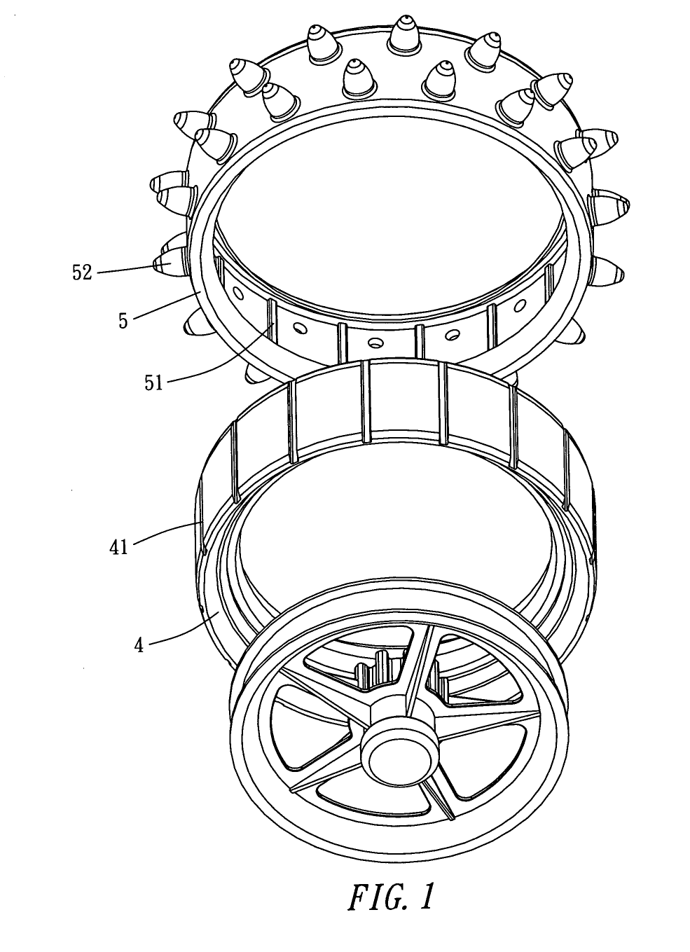

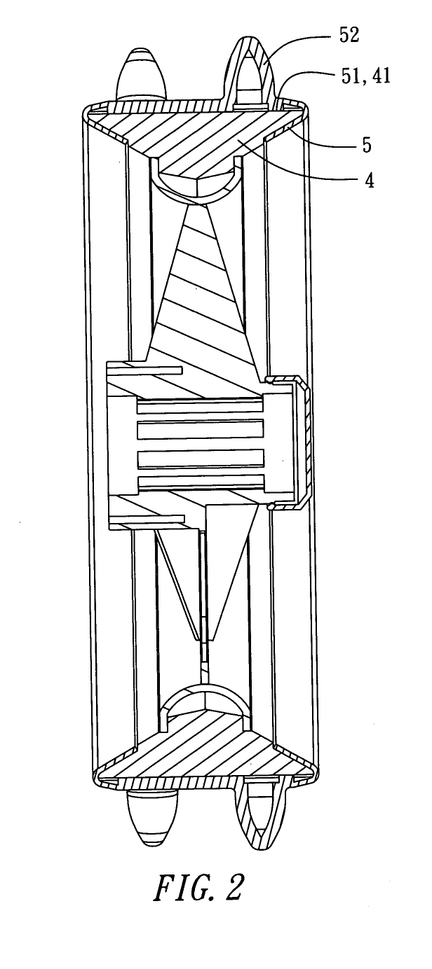

Referring to the drawings and initially to FIGS. 1 and 2, a tire for a golf cart in accordance with a first preferred embodiment of the present invention comprises an inner tire 4 made of EVA solid foam material, and a thin outer tire 5 mounted around the inner tire 4. The inner tire 4 has an outer wall formed with a plurality of transverse slots 41. The thin outer tire 5 is made of elastic soft material, such as rubber, TPE, TPU or the like. The thin outer tire 5 is substantially inverted U-shaped. The thin outer tire 5 has an inner wall formed with a plurality of transverse ribs 51 locked in the transverse slots 41 of the inner tire 4 respectively. The thin outer tire 5 has an outer wall formed with a plurality of protruding bosses 52 each having a substantially pointed cylindrical shape.

In assembly, as shown in FIG. 2, the thin outer tire 5 is closely mounted around a periphery of the inner tire 4 by its elasticity. In addition, the transverse ribs 51 of the thin outer tire 5 are locked in the transverse slots 41 of the inner tire 4 respectively to prevent the thin outer tire 5 and the inner tire 4 from producing idle rotation or slip movement. In addition, the pointed cylindrical shaped protruding bosses 52 of the thin outer tire 5 can be extended into the muddy or snowy ground to provide an excellent grip effect, so that the golf cart can be moved smoothly and conveniently. In addition, the thin outer tire 5 can be detached from the inner tire 4 during the season without rain or the winter without snow, so that the inner tire 4 functions as a tire individually.

Accordingly, the inner tire 4 made of EVA solid foam material co-operates with the thin outer tire 5 having a plurality of protruding bosses 52 to construct a solid composite tire, so that the tire has a light weight, needs not to be inflated and has a better shock-absorbing effect. In addition, the pointed cylindrical shaped protruding bosses 52 of the thin outer tire 5 can be extended into the muddy or snowy ground to provide an excellent grip effect, so that the golf cart can be moved smoothly and conveniently.

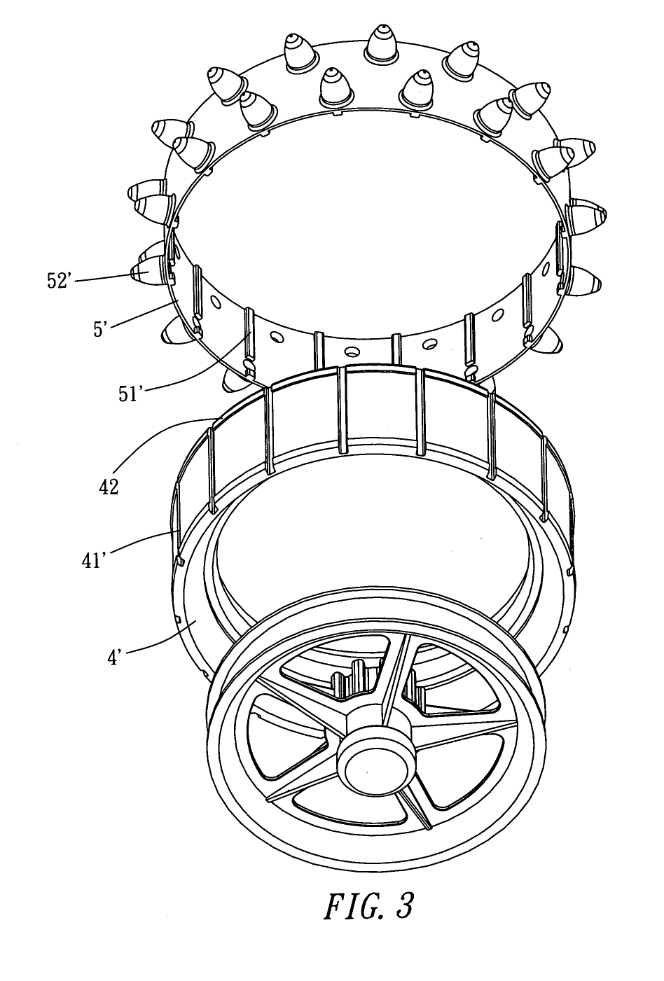

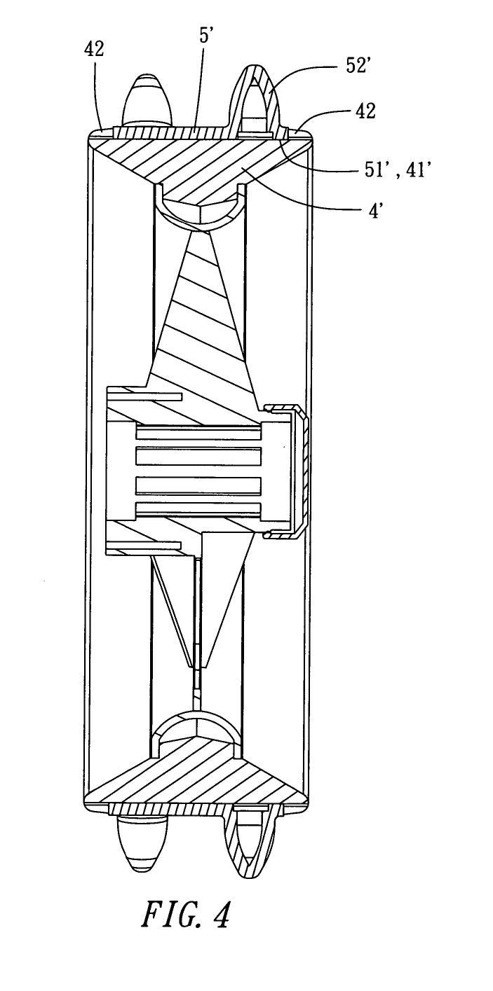

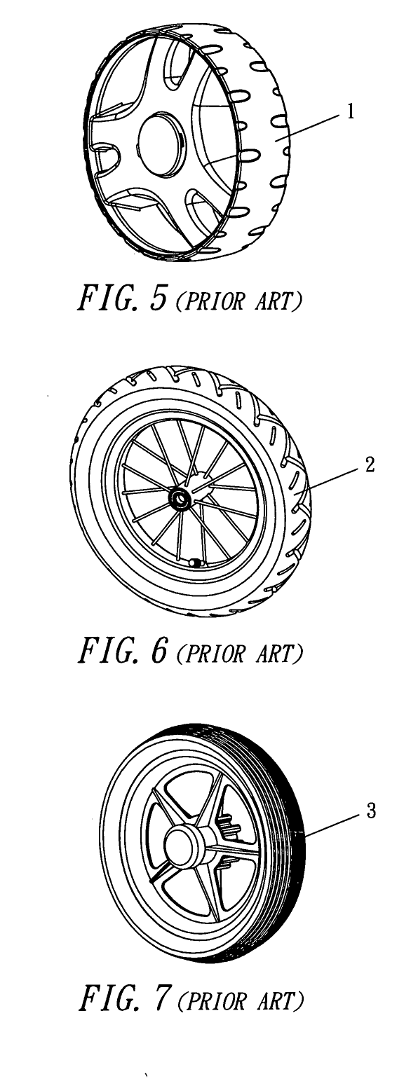

Referring to FIGS. 3 and 4, a tire for a golf cart in accordance with a second preferred embodiment of the present invention comprises an inner tire 4″ made of EVA solid foam material, and a thin outer tire 5″ mounted around the inner tire 4″. The inner tire 4″ has an outer wall formed with a plurality of transverse slots 41″. The outer wall of the inner tire 4″ has two opposite sides each formed with a protruding baffle 42 so that the outer wall of the inner tire 4″ has an annular groove. The thin outer tire 5″ has a substantially annular thin-plate shape. The thin outer tire 5″ has an inner wall formed with a plurality of transverse ribs 51″ locked in the transverse slots 41″ of the inner tire 4″ respectively. The thin outer tire 5″ has an outer wall formed with a plurality of protruding bosses 52″ each having a substantially pointed cylindrical shape. The protruding bosses 52″ of the thin outer tire 5″ have equal height and thickness.

In assembly, as shown in FIG. 4, the thin outer tire 5″ is closely mounted in the annular groove of the inner tire 4″, and the transverse ribs 51″ of the thin outer tire 5″ are locked in the transverse slots 41″ of the inner tire 4″ respectively, so that the inner tire 4″ co-operates with the thin outer tire 5″ to construct a solid composite tire. Thus, the tire in accordance with the second preferred embodiment of the present invention has the same effect as that of the tire in accordance with the first preferred embodiment of the present invention.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A tire for a golf cart, comprising an inner tire made of EVA solid foam material, and a thin outer tire mounted around the inner tire, wherein:
the inner tire has an outer wall formed with a plurality of transverse slots;
the thin outer tire has an inner wall formed with a plurality of transverse ribs locked in the transverse slots of the inner tire respectively;
the thin outer tire has an outer wall formed with a plurality of protruding bosses.

2. The tire in accordance with claim 1, wherein the thin outer tire is made of elastic soft material.

3. The tire in accordance with claim 1, wherein the thin outer tire is substantially inverted U-shaped

4. The tire in accordance with claim 3, wherein the thin outer tire is closely mounted around a periphery of the inner tire by its elasticity.

5. The tire in accordance with claim 1, wherein each of the protruding bosses of the thin outer tire has a substantially pointed cylindrical shape.

6. The tire in accordance with claim 1, wherein the protruding bosses of the thin outer tire can be extended into the muddy or snowy ground to provide an excellent grip effect.

7. The tire in accordance with claim 1, wherein the thin outer tire can be detached from the inner tire.

8. The tire in accordance with claim 1, wherein the inner tire 4 made of EVA solid foam material co-operates with the thin outer tire having a plurality of protruding bosses to construct a solid composite tire.

9. The tire in accordance with claim 1, wherein the outer wall of the inner tire has an annular groove, and the thin outer tire is closely mounted in the annular groove of the inner tire.

10. The tire in accordance with claim 11, wherein the outer wall of the inner tire has two opposite sides each formed with a protruding baffle so that the protruding baffles of the two opposite sides of the outer wall of the inner tire form the annular groove.

11. The tire in accordance with claim 11, wherein the thin outer tire has a substantially annular thin-plate shape.
